(19) United States
(12) Patent Application Publication
(10) Pub. No.: US 2025/0015690 A1
(43) Pub. Date: Jan. 9, 2025

(54) METHOD FOR MANUFACTURING STATOR, MANUFACTURING DEVICE, AND HOLDER

(71) Applicants: HITACHI ASTEMO, LTD., Hitachinaka-shi (JP); HIRATA CORPORATION, Kumamoto-shi (JP)

(72) Inventors: Akira TOBA, Hitachinaka-shi (JP); Yasuhiko KIMURA, Hitachinaka-shi (JP); Osamu FUJITA, Kumamoto-shi (JP); Yoshitaka MOTODA, Kumamoto-shi (JP)

(73) Assignees: HITACHI ASTEMO, LTD., Hitachinaka-shi (JP); HIRATA CORPORATION, Kumamoto-shi (JP)

(21) Appl. No.: 18/888,257

(22) Filed: Sep. 18, 2024

Related U.S. Application Data
(63) Continuation of application No. PCT/JP2022/014595, filed on Mar. 25, 2022.

(51) Int. Cl. H02K 15/085

(52) U.S. Cl. CPC H02K 15/085

(57) ABSTRACT

A holder for positioning ends of coil conductors constituting a coil of a stator, wherein the ends of the coil conductors protrude in an axial direction and are arranged in the circumferential direction so as to form a row in the radial direction, comprises positioning members each configured to rotate about the radial direction as a rotation axis to bring a section of a positioning portion extending to the one side in contact with the ends forming the rows on one side in the circumferential direction, bring a section of the positioning portion extending to another side in contact with the ends forming the rows on another side, and thereby position the ends forming the rows together with the positioning portion of another adjacent positioning member.

### CROSS-REFERENCE TO RELATED APPLICATION(S)

This application is a continuation of International Patent Application No. PCT/JP2022/014595 filed on Mar. 25, 2022, the entire disclosures of which is incorporated herein by reference.

### BACKGROUND OF THE INVENTION

### Field of the Invention

The present invention mainly relates to a holder.

### Description of the Related Art

Japanese Patent Laid-Open No. 2005-224028, Japanese Patent No. 6451993, Japanese Patent No. 6558876, and Japanese Patent Laid-Open No. 2006-502688 each disclose manufacturing a stator by connecting ends of a plurality of coil conductor to form a coil, the coil conductors being attached to a stator body constituting a motor. According to such a manufacturing method, the plurality of coil conductors forms a stator coil, whereby the stator is applicable to a predetermined motor.

### SUMMARY OF THE INVENTION

It is considered that it takes relatively a long time to connect the ends in consideration of the number of the plurality of coil conductors, an increase in man-hours associated therewith, and the like, and a technique advantageous for improving the manufacturing efficiency of the stator is demanded.

An object of the present invention is to improve manufacturing efficiency of a stator.

An aspect of the present invention relates to a holder for positioning ends of a plurality of coil conductors constituting a coil of a stator to be mounted on a motor, the holder comprising: a plurality of positioning members arranged side by side at predetermined intervals in a circumferential direction so as to be able to position the ends of the plurality of coil conductors; an outer annular member that is disposed on an outer side that is one side in a radial direction, the outer annular member holding the plurality of positioning members; and an inner annular member that is disposed on an inner side that is another side in the radial direction, the inner annular member holding the plurality of positioning members, wherein each of the positioning members is a rod-shaped member extending in the radial direction, and includes a rotation shaft configured to be rotatable about the radial direction as a rotation axis, and a positioning portion provided to extend to one side and another side in a direction orthogonal to the radial direction, the ends of the plurality of coil conductors protrude in an axial direction of the motor and are arranged in the circumferential direction so as to form a row in the radial direction, each of the plurality of positioning members is arranged to be located between a plurality of the rows of the ends of the plurality of coil conductors arranged in the circumferential direction, the outer annular member is provided with a plurality of first holding portions that respectively holds sections on one side in the radial direction of the rotation shafts of the plurality of positioning members in a rotatable manner, the inner annular member is provided with a plurality of second holding portions that respectively holds sections on another side in the radial direction of the rotation shafts of the plurality of positioning members in a rotatable manner, and each of the positioning members rotates about the radial direction as a rotation axis to bring a section of the positioning portion extending to the one side in contact with the ends forming the rows on one side in the circumferential direction, bring a section of the positioning portion extending to another side in contact with the ends forming the rows on another side in the circumferential direction, and position the ends forming the rows together with the positioning portion of another adjacent positioning member in the circumferential direction among the plurality of positioning members.

According to the present invention, it is possible to improve the manufacturing efficiency of the stator.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic external diagram illustrating a configuration example of a manufacturing device;

FIG. 2 is a schematic diagram illustrating a configuration example of a stator;

FIG. 3 is a schematic diagram illustrating a configuration example of a holder;

FIG. 4A is a schematic diagram illustrating an example of a structure of a positioning member;

FIG. 4B is a schematic diagram illustrating an example of the structure of the positioning member;

FIG. 4C is a schematic diagram illustrating an example of the structure of the positioning member;

FIG. 5A1 is a schematic diagram illustrating an example of an orientation of the positioning member;

FIG. 5A2 is a schematic diagram illustrating an example of an orientation of the positioning member;

FIG. 5B1 is a schematic diagram illustrating an example of an orientation of the positioning member;

FIG. 5B2 is a schematic diagram illustrating an example of an orientation of the positioning member;

FIG. 6 is a flowchart illustrating an example of a method for manufacturing a stator;

FIG. 7A is a schematic top view illustrating a trajectory of a joining tool;

FIG. 7B is a schematic top view illustrating a trajectory of the joining tool;

FIG. 8 is a schematic diagram illustrating another example of the positioning member; and

FIG. 9 is a schematic diagram illustrating another example of the positioning member.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration Example of Manufacturing Device

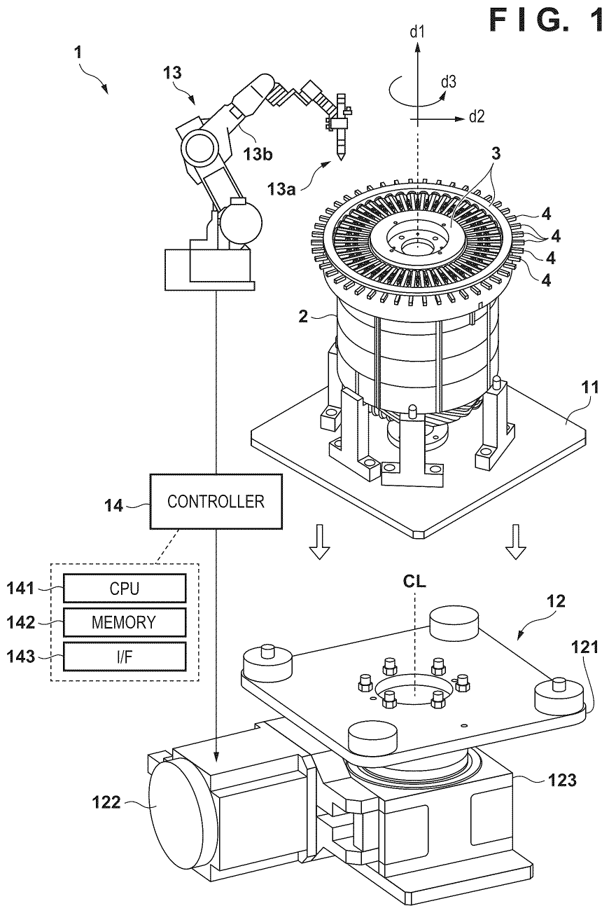

FIG. 1 is an external diagram illustrating a configuration example of a manufacturing device 1 according to an embodiment. The manufacturing device 1 can be used to manufacture a stator 2 to be mounted on a motor. Directions d1, d2, and d3 indicated by arrows in the figure respectively correspond to an axial direction that is a direction in which an axis of the stator 2 (or the motor) extends, a radial direction that is a direction intersecting the axial direction, and a circumferential direction about the axis. In the present embodiment, the stator 2 can be manufactured with the axial direction d1 as the perpendicular direction, the vertical direction, or the height direction, and the radial direction d2 and the circumferential direction d3 as the horizontal direction.

When the relative positional relationship between two or more elements is expressed, the −d1 direction may be expressed as a downward direction or one direction, and the +d1 direction may be expressed as an upward direction or another direction. Similarly, the −d2 direction may be expressed as an inward direction, the +d2 direction may be expressed as an outward direction, the −d3 direction may be expressed as a clockwise (CW) direction, and the +d3 direction may be expressed as a counterclockwise (CCW) direction.

Note that the manufacture described herein is to be construed in a broad sense, and may conceptually include not only acts directly contributing to the manufacture, such as production, formation, attachment, welding, joining, and connection, but also acts indirectly contributing to the manufacture, such as preparation, installation, and arrangement of elements necessary for implementing the above acts.

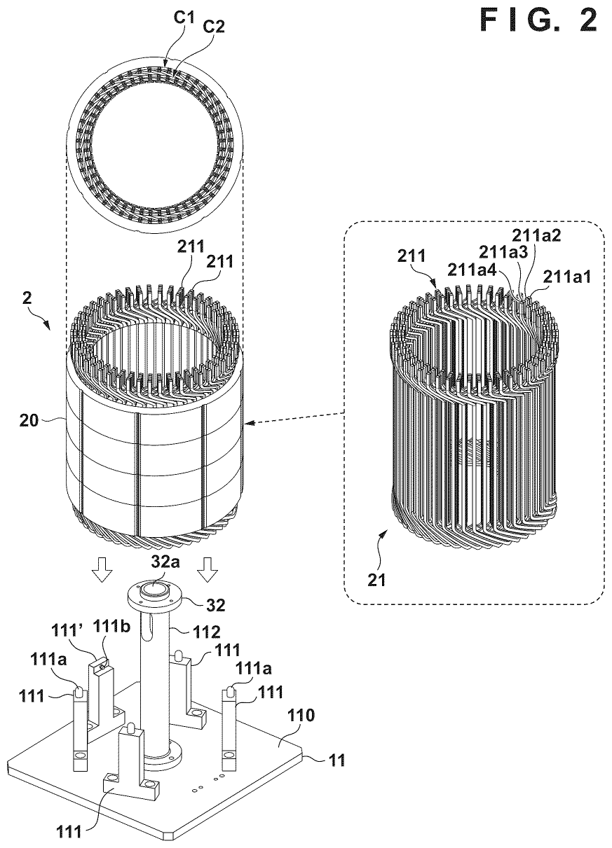

FIG. 2 illustrates a configuration example of the stator 2.

The stator 2 is formed by winding a coil (stator coil) including a plurality of coil conductors 21 around a stator body 20. The stator body 20 has a plurality of grooves (slots) extending in the d1 direction, and the plurality of coil conductors 21 is inserted into the plurality of grooves. Note that portions of the plurality of coil conductors 21 that pass through the plurality of grooves are covered with insulating paper (slot liner).

The plurality of coil conductors 21 is arranged in the radial direction d2 and the circumferential direction d3, and a plurality of ends 211 thereof is arranged in the radial direction d2 and along a plurality of circumferential tracks in the circumferential direction d3, and protrudes from and is exposed above the stator body 20.

Each of the plurality of coil conductors 21 is formed by cutting a conductive extension member covered with an insulating film and removing the insulating film at both ends of the cut portion over a predetermined width. In the present embodiment, the portion from which the insulating film is removed is defined as the end 211 of the coil conductor 21.

As will be described in detail later, two ends 211 adjacent to each other in the radial direction d2 of the plurality of coil conductors 21 described above are sequentially connected to each other by welding.

In FIG. 2, the ends 211 of four given coil conductors 21 are arranged in the radial direction d2 from the outside to the inside, and are indicated as ends 211a1, 211a2, 211a3, and 211a4. As will be described in detail later, among the ends 211a1 to 211a4, the two ends 211a1 and 211a2 on the outer side are connected to each other as one set, and the two ends 211a3 and 211a4 on the inner side are connected to each other as one set. A plurality of similar configurations is circumferentially provided in the circumferential direction d3, although the description of the ends 211 of another four coil conductors 21 is omitted.

In the present embodiment, the plurality of coil conductors 21 is arranged such that the ends 211 thereof protrude and are exposed along two circumferential tracks about the axis of the stator 2, an outer circumferential track (first circumferential track) c1 and an inner circumferential track (second circumferential track) c2. More specifically, the two ends 211 adjacent to each other in the radial direction d2 are defined as one set, and sets of two ends 211 adjacent to each other correspond to the outer circumferential track c1 (for example, the ends 211a1 and 211a2) and the inner circumferential track c2 (for example, the ends 211a3 and 211a4), respectively.

To sum up, according to the present embodiment, four ends 211 arranged in the radial direction d2 are arranged at predetermined intervals in the circumferential direction d3, and two of the four ends on the outer side are connected to each other as one set and two of the four ends 211 on the inner side are connected to each other as one set. Thus, the plurality of coil conductors 21 forms a coil of the stator 2.

Referring to FIG. 1 again, the manufacturing device 1 includes a support 11, a rotation mechanism 12, a joining unit 13, and a controller 14.

The support 11 is used to support the stator 2 being manufactured. In the present embodiment, the support 11 supports the stator body 20 from one end side (here, lower end side) in the axial direction d1.

As illustrated in FIG. 2, the support 11 includes a support plate 110, a column portion 112 provided on the support plate 110, and a plurality of stands 111 and 111′ circumferentially provided on the support plate 110 about the column portion 112.

Each of the plurality of stands 111 and 111′ supports the lower end of the stator body 20. The stand 111 is provided with a pin 111a extending in the axial direction d1, and the pin 111a comes in contact with or is fitted to the stator body 20 when the stand 111 supports the stator body 20. The stand 111′ is provided with a pin 111b extending in the radial direction d2, and the pin 111b comes in contact with or is fitted to the stator body 20 when the stand 111′ supports the stator body 20. With the configuration described above, the stator body 20 can be positioned in the axial direction d1 and the radial direction d2 by the stands 111 and the stator body 20 can be positioned in the circumferential direction d3 by the stands 111′. Accordingly, the support 11 fixes the stator body 20. The numbers of the stands 111 and 111′ are not limited to those in the illustrated example.

The column portion 112 extends to pass through the inside of the stator body 20 and has, on its upper end, a defining portion 32 that supports the holder 3 to be described later and defines the position of the holder 3. As will be described later in detail, the support 11 is rotatable about the axial direction d1 as a rotation axis while supporting the stator 2.

The rotation mechanism 12 is configured to rotate the support 11 in the circumferential direction d3 about a center line CL parallel to the axial direction d1. In the present embodiment, the rotation mechanism 12 includes a rotary support base 121, a rotation drive unit 122, and a speed detection unit 123. The rotary support base 121 is configured such that the support 11 supporting the stator 2 can be placed thereon, and the rotation drive unit 122 rotates the rotary support base 121 to rotate the stator 2 together with the support 11. As will be described in detail later, the rotary support base 121 is rotatable bidirectionally (selectively in both the +d3 direction and the −d3 direction) about the axial direction d1 as a rotation axis.

Note that the speed detection unit 123 that is incorporated in the rotation drive unit 122 in the present embodiment may be attached to the rotation drive unit 122 as an accessory as another embodiment.

The speed detection unit 123 is configured to be able to detect the rotation speed of the rotary support base 121. As will be described in detail later, the speed detection unit 123 periodically detects the rotation speed during rotation of the rotary support base 121. A known sensor such as an optical encoder may be used as the speed detection unit 123, and the speed detection unit 123 may be provided to the rotation axis of the rotary support base 121.

Although the present embodiment describes a mode in which the support 11 and the rotation mechanism 12 are separate components, the rotation mechanism 12 may be partly or entirely formed integrally with the support 11. For example, the support 11 may have a function of the rotary support base 121.

The joining unit 13 includes a joining tool 13a and an arm portion 13b. The joining tool 13a is disposed on the other end side (here, the upper end side) in the axial direction d1 with respect to the stator 2. The joining tool 13a is configured to approach the ends 211 of the coil conductors 21 from the other end side in the axial direction d1 to join the ends 211. The arm portion 13b is a movable mechanism that movably holds the joining tool 13a, and can move the joining tool 13a from given ends 211 to the other ends 211, for example. Note that a known articulated robot may be used for the arm portion 13b, and may be driven and controlled by the controller 14 described later independently of the joining tool 13a.

The joining tool 13a can be moved in the planar direction and also can be moved up and down by the arm portion 13b. In the present embodiment, the joining tool 13a joins at least portions of the ends 211 of the coil conductors 21 (the entire regions of the portions from which the insulating films are removed or a part of the portions on the cut surface side) by welding. In the present embodiment, arc welding, for example, tungsten inert gas (TIG) welding, is used as the welding. However, it is only necessary to select an appropriate method from known metallurgical joining methods such as laser welding.

Here, the arm portion 13b is controlled not to come into contact with the ends 211 of the coil conductors 21 while the joining tool 13a moves and performs the joining process and to set a distance by which an arc can be appropriately generated between the ends 211 and the joining tool 13a during the execution of the joining process.

As will be described in detail later, the joining unit 13 repeats joining two given ends 211 by the joining tool 13a, then moving the joining tool 13a to the next two ends 211 by the arm portion 13b, and joining the ends by the joining tool 13a. In this way, the joining unit 13 sequentially connects the two adjacent ends 211 of the plurality of coil conductors 21.

The controller 14 periodically controls individual elements described in the present embodiment. Specifically, the controller 14 periodically performs drive control of the rotation drive unit 122, drive control of the arm portion 13b, and detection by the speed detection unit 123.

As will be described in detail later, the controller 14 reciprocates the joining tool 13a by the arm portion 13b while calculating the relative position of the joining tool 13a with respect to the stator 2 on the basis of the detection result of the speed detection unit 123, thereby sequentially connecting the adjacent two ends 211 to each other.

A plurality of drivers such as a movement control driver and a joining control driver can be used so that the drive control of the joining unit 13 is appropriately achieved, and some or all of the functions of the drivers may be implemented by the controller 14.

The controller 14 includes a central processing unit (CPU) 141, a memory 142, and an external communication interface 143. Each of functions of the manufacturing device 1 described below is executed by the CPU 141 loading a predetermined program on the memory 142 and executing the program. The concept of the memory 142 may include a read only memory (ROM) in addition to a random access memory (RAM). The program may be read from a non-volatile memory such as a hard disk drive (HDD) or a solid state drive (SSD), or may be read via the external communication interface 143.

Note that the controller 14 may be configured by a semiconductor device such as an application specific integrated circuit (ASIC), that is, each of the functions of the manufacturing device 1 may be implemented by either hardware or software.

### Configuration Example of Holder

The holder 3 is configured to position the ends 211 of two coil conductors 21 adjacent to each other in the radial direction d2.

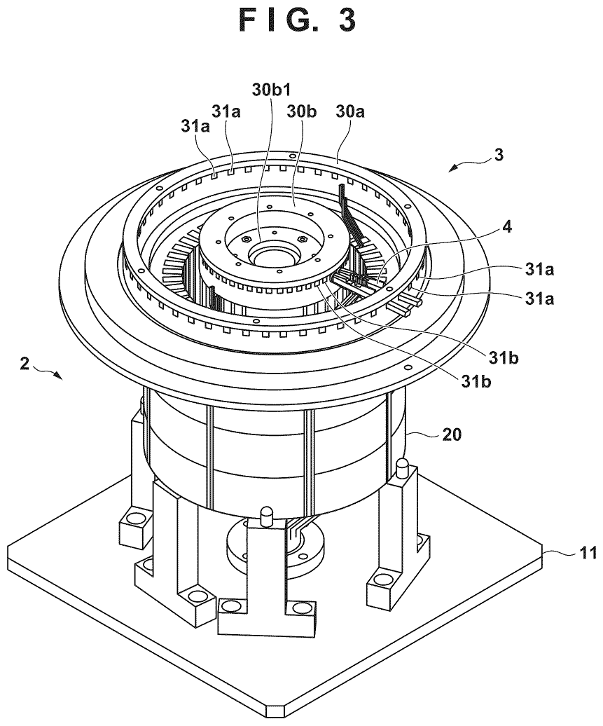

FIG. 3 is a schematic diagram illustrating a configuration example of the holder 3. The holder 3 includes a plurality of positioning members 4 for positioning the ends 211 of the plurality of coil conductors 21. The plurality of positioning members 4 is arranged at predetermined intervals or arranged side by side in the circumferential direction d3 (only some of the coil conductors 21 and the positioning members 4 are illustrated herein for easy understanding). Each of the positioning members 4 is a rod-shaped member extending in the radial direction d2 and configured to be rotatable about the radial direction d2 as a rotation axis.

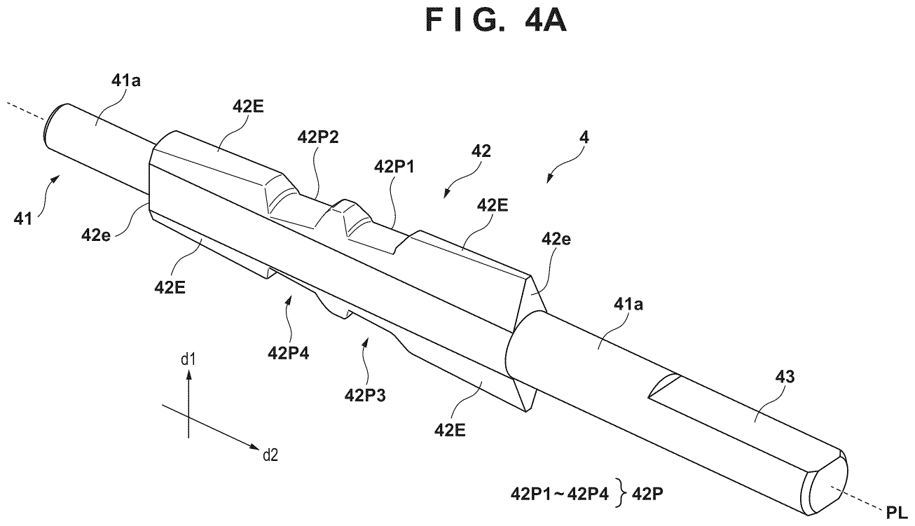

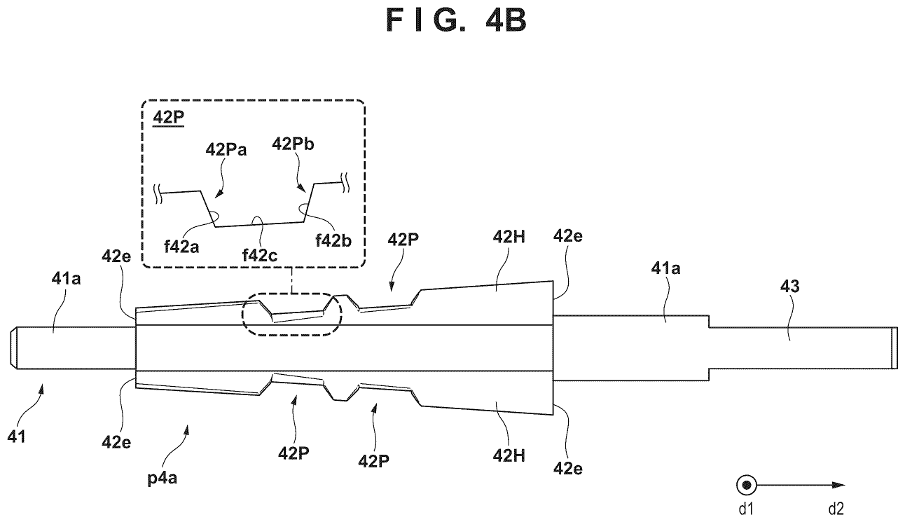

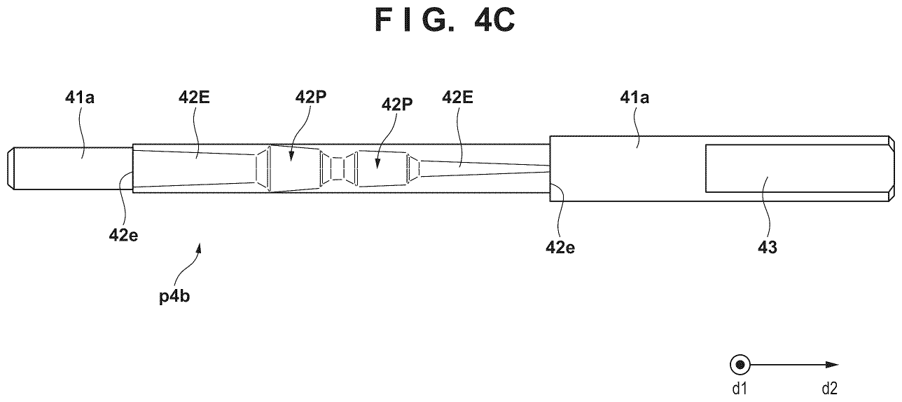

FIG. 4A is a perspective view illustrating an example of a structure of a single positioning member 4. FIG. 4B is a diagram (top view) of the positioning member 4 in a later-described orientation p4a as viewed in the axial direction d1. FIG. 4C is a diagram of the positioning member 4 in a later-described orientation p4b as viewed in the axial direction d1.

The positioning member 4 includes a rotation shaft 41, a positioning portion 42, and an operation portion 43. The rotation shaft 41 is a rod-shaped member and has the positioning portion 42 provided at a central part thereof. The rotation shaft 41 is configured to be rotatable about a center line PL parallel to the radial direction d2 as a rotation axis. The rotation shaft 41 includes rotation engagement portions 41a that engage with the holder 3 during the rotation. In the present embodiment, the rotation engagement portions 41a are provided respectively on one side and the other side in the axial direction of the rotation shaft 41 extending along the center line PL with respect to the positioning portion 42.

The positioning portion 42 includes a pair of blade portions 42H provided to extend respectively on one side and the other side in a direction orthogonal to the center line PL between the rotation engagement portions 41a. Each of the blade portions 42H includes a side portion 42E that is formed to have an increased width and a decreased thickness from the inside toward the outside (in the +d2 direction), and an extension portion 42e that extends to connect the rotation shaft 41 and the side portion 42E. The side portion 42E is provided with a positioning contact portion 42P (in the present embodiment, four positioning contact portions 42P1, 42P2, 42P3, and 42P4) that comes into contact with the ends 211 when the ends 211 of the coil conductor 21 are positioned.

In the present embodiment, the positioning contact portions 42P provided on the side portion 42E of each of the pair of blade portions 42H are provided on the outer side and the inner side in the radial direction d2 so as to correspond to the two circumferential tracks c1 and c2, respectively. That is, the single positioning member 4 has a total of four positioning contact portions 42P.

Each of the positioning contact portions 42P includes a first contact portion 42Pa and a second contact portion 42Pb. The contact portion 42Pa can contact the end 211 of one of the two coil conductors 21 adjacent to each other in the radial direction d2 and can bring the end 211 of the one of the coil conductors 21 close to the end 211 of the other coil conductor 21 by the contact. The contact portion 42Pb can contact the end 211 of the other of the two coil conductors 21 and can bring the end 211 of the other coil conductor 21 close to the end 211 of the one coil conductor 21 by the contact.

In the present embodiment, two positioning contact portions 42P spaced apart from each other in the radial direction d2 are provided in each of the pair of side portions 42E. That is, one of the side portions 42E is provided with the two positioning contact portions 42P1 and 42P2, and the other side portion 42E is provided with the two positioning contact portions 42P3 and 42P4.

Therefore, the positioning contact portions 42P1 and 42P3 on the outer side (+d2 direction side) bring the ends 211 of the two coil conductors located on the outer circumferential track c1 and adjacent to each other in the radial direction d2 close to each other by the contact and position the same. Similarly, the positioning contact portions 42P2 and 42P4 on the inner side (−d2 direction side) bring the ends 211 of the two coil conductors located on the inner circumferential track c2 and adjacent to each other in the radial direction d2 close to each other and position the same.

Each of the positioning contact portions 42P is formed into a recessed shape and includes a first inclined surface f42a functioning as the contact portion 42Pa, a second inclined surface f42b functioning as the contact portion 42b, and a connection surface f42c that connects the inclined surfaces f42a and f42b. The inclined surfaces f42a and f42b are inclined such that the distance therebetween increases in the direction from the inside to the outside along the rotation shaft 41.

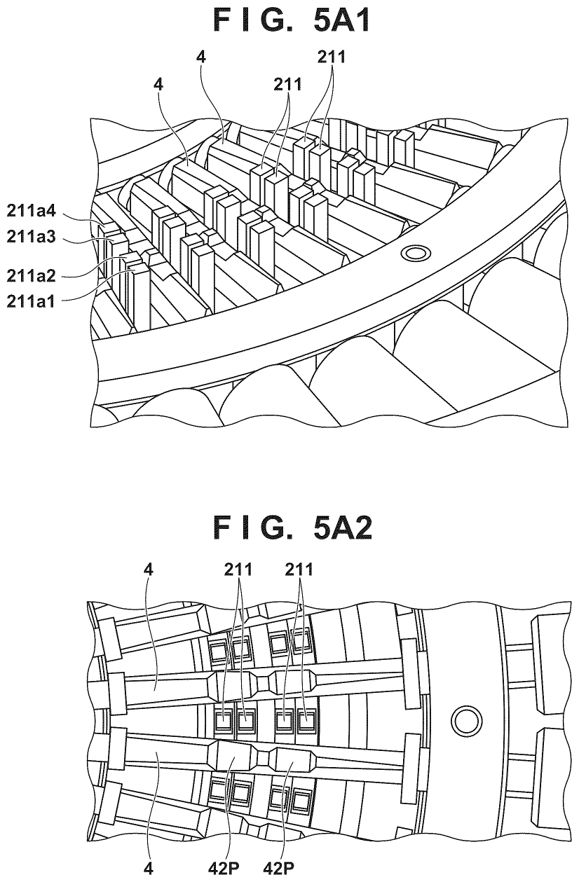

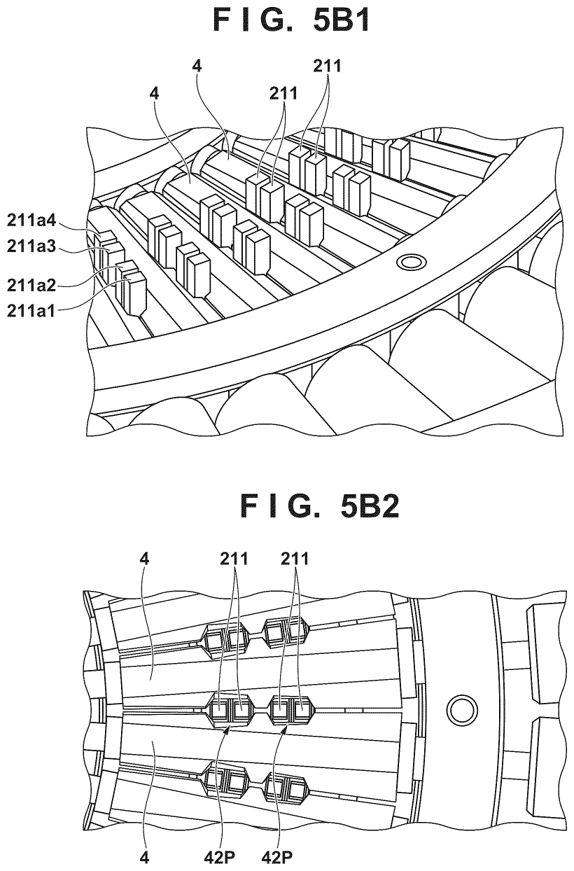

FIG. 5A1 is a perspective view of the plurality of positioning members 4 in the orientation p4a and the corresponding ends 211 of the plurality of coil conductors 21, and FIG. 5A2 is a top view thereof (as viewed in the axial direction d1). FIG. 5B1 is a perspective view of the plurality of positioning members 4 in the orientation p4b and the corresponding ends 211 of the plurality of coil conductors 21, and FIG. 5B2 is a top view thereof.

The positioning member 4 can be selectively in the orientation p4a or p4b. As illustrated in FIGS. 5A1 and 5A2, when the positioning member 4 is in the orientation p4a, the positioning contact portion 42P is oriented in the axial direction d1 and is separated from the ends 211 of the two coil conductors 21 adjacent to each other in the radial direction d2. As illustrated in FIGS. 5B1 and 5B2, when the positioning member 4 is in the orientation p4b, the positioning contact portion 42P is oriented in the radial direction d2 and is in close contact with the ends 211 of the two coil conductors 21 adjacent to each other in the radial direction d2.

In other words, the ends 211 of the two coil conductors 21 adjacent to each other in the radial direction d2 can be brought close to each other by the positioning contact portion 42P of the positioning member 4 (referred to as “positioning member 4a” for distinction) adjacent thereto on one side in the circumferential direction d3 and the positioning contact portion 42P of the positioning member 4 (referred to as “positioning member 4b” for distinction) adjacent thereto on the other side. In this way, the plurality of positioning members 4 bring the two adjacent coil conductors 21 close to each other and position them, so that the joining tool 13a can appropriately approach the ends 211 of the coil conductors 21.

In addition, as illustrated in FIG. 5B2, the plurality of positioning members 4 is preferably configured such that two side portions 42E facing each other between two adjacent positioning members 4 are parallel and close to each other in the orientation p4b. This makes it possible to shield and/or dissipate welding heat that could propagate downward from the sections of the ends 211 with which the positioning members 4 come in contact during joining (described later) of the ends 211. Thus, the influence of the welding heat can be reduced, and the quality of the stator 2 can be improved. Examples of the influence of the welding heat include burn and scorch of an enamel material constituting the insulating film of the coil conductor 21.

The positioning portion 42 fixes or retains the ends 211, and in this respect, it may be expressed as an end fixing portion, an end retaining portion, or the like, or may be simply expressed as a fixing portion, a retaining portion, or the like.

Referring again to FIGS. 4A to 4C, the operation portion 43 is configured to switch the positioning member 4 between the orientation p4a and the orientation p4b using an operation mechanism (not illustrated). In the present embodiment, the operation portion 43 is provided outside the rotation shaft 41 in the radial direction d2. Furthermore, the operation portion 43 may be configured to be graspable by the operation mechanism (not illustrated), and in this respect, may be expressed as a grip portion 43. Note that examples of the operation mechanism here include an operation mechanism (for example, a manipulator) that performs manufacturing work on the basis of a predetermined command.

Referring again to FIG. 3, the holder 3 has a plurality of first holding portions 31a and a plurality of second holding portions 31b. Each of the holding portions 31a rotatably holds the rotation engagement portion 41a on one side (here, the outer side) in the radial direction d2 of the rotation shaft 41. Each of the holding portions 31b rotatably holds the rotation engagement portion 41a on the other side (here, the inner side) in the radial direction d2 of the rotation shaft 41. In the present embodiment, the holder 3 includes an outer annular member 30a and an inner annular member 30b. The outer annular member 30a and the inner annular member 30b are connected by the plurality of positioning members 4 being mounted thereto. The plurality of holding portions 31a is provided on the outer annular member 30a, and the plurality of holding portions 31b is provided on the inner annular member 30b. The plurality of positioning members 4 may be included in the concept of the holder 3.

Each of the plurality of positioning members 4 is configured as described above and is disposed so as to be positioned between the ends 211 of the plurality of coil conductors 21. In other words, the holder 3 can position the ends 211 of the plurality of coil conductors 21 by the plurality of positioning members 4. It can also be said that each positioning member 4 has at least partially a function of positioning the ends 211 of the two coil conductors 21 present on both sides thereof, and achieves the function together with the other adjacent positioning member 4 in the circumferential direction d3.

The holder 3 is attached to the defining portion 32 provided at the upper end of the column portion 112 and is defined in terms of the position and orientation. The defining portion 32 has a cylindrical protrusion 32a on the upper end face thereof (see FIG. 2). The holder 3 has an inner peripheral wall 30b1 that has a hole formed at a central part of the inner annular member 30b (see FIG. 3). The position of the inner annular member 30b of the holder 3 in the radial direction d2 is defined by engagement between the outer peripheral surface of the protrusion 32a and the inner peripheral surface of the inner peripheral wall 30b1.

Further, a positioning pin (not illustrated) is provided on one of a support surface (upper end face) of the defining portion 32 and a supported surface (bottom surface) of the inner annular member 30b, and a positioning hole (not illustrated) is provided on the other. The position of the holder 3 in the circumferential direction d3 is defined by the positioning pin and the positioning hole being fitted to each other.

In the present embodiment, the supported surface (bottom surface) of the inner annular member 30b and the support surface (upper end face) of the defining portion 32 contact each other, and the supported surface (bottom surface) of the outer annular member 30a and the upper end face of the stator body 20 contact each other. Thus, the position of the outer annular member 30a of the holder 3 in the axial direction d1 is defined. In addition, the inner peripheral surface of the outer annular member 30a and the outer peripheral surface of the upper end of the stator body 20 contact each other. Thus, the position of the outer annular member 30a in the radial direction d2 is defined.

To sum up, the plurality of coil conductors 21 is mounted on the stator body 20 such that the ends 211 thereof protrude beyond and are exposed from the end of the stator body 20 above the stator body 20, and the individual ends 211 can be positioned in the radial direction d2 and the circumferential direction d3 by the positioning members 4.

### Manufacturing Method

The ends 211 of the plurality of coil conductors 21 are appropriately positioned in the radial direction d2 and the circumferential direction d3 at positions below the end faces of the ends 211 in the axial direction d1 by the holder 3 described above. Accordingly, the two ends 211 adjacent to each other in the radial direction d2 can be more appropriately joined to each other by the joining unit 13. Thus, the stator 2 can be manufactured relatively simply in a relatively short time.

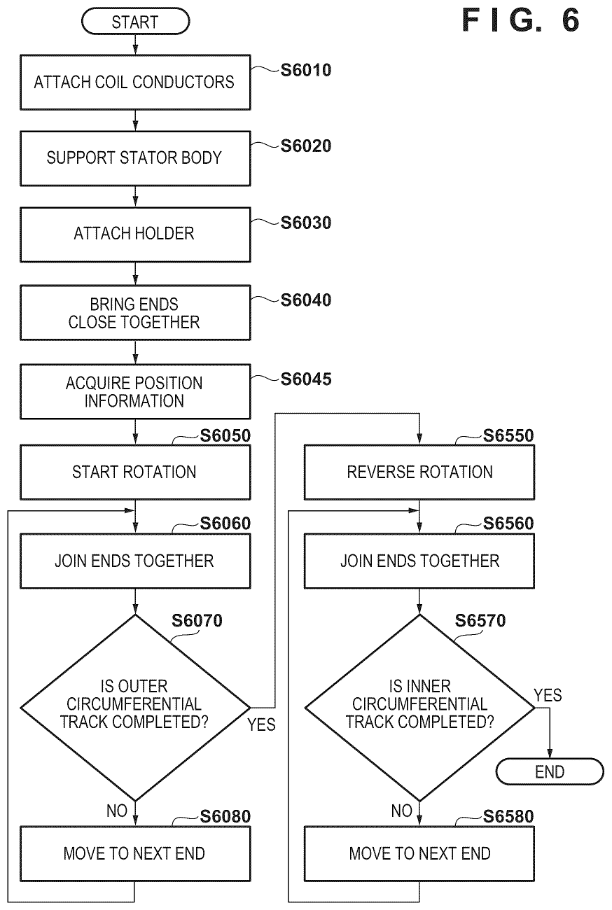

FIG. 6 is a flowchart illustrating a method for manufacturing the stator 2 according to the present embodiment. This flowchart is implemented by attaching the plurality of coil conductors 21 to the stator body 20, and then by driving and controlling the corresponding elements mainly by the controller 14 to sequentially connect the ends 211 of the plurality of coil conductors 21. The outline is that the two adjacent ends 211 are connected to each other while the joining tool 13a reciprocates with respect to the stator 2 that is being manufactured and that rotates about the axial direction d1 as a rotation axis.

In step S6010 (hereinafter, simply referred to as S6010, and the same applies to other steps described later), the plurality of coil conductors 21 is attached to the main body of the stator 2. In the present embodiment, the ends 211 of the plurality of coil conductors 21 is arranged in the circumferential direction d3 to form four rows in the radial direction d2 on the upper side. The arranged ends 211 are connected in a later step, so that the plurality of coil conductors 21 form three-phase power lines of a U phase, a V phase, and a W phase as coils.

In S6020, the stator body 20 is supported by the support 11 (supporting step). Thus, the stator 2 can be rotated together with the support 11 by the rotation mechanism 12, and the rotation speed of the support 11 is detected by the speed detection unit 123.

Here, when the stator 2 is supported by the support 11, or before and after the stator 2 is supported by the support 11, the controller 14 may acquire information regarding the stator 2. Examples of the information regarding the stator 2 include information indicating the configuration of the stator 2, for example, information indicating the number of the ends 211 of the coil conductors 21, the arrangement positions thereof, and the like. The information regarding the stator 2 may be acquired on the basis of an IC tag or the like of a pallet that can be used in a manufacturing line of the stator 2, or may be acquired from a predetermined code (for example, a two-dimensional code) printed on the stator 2.

In S6030, the holder 3 that positions the ends 211 of the two coil conductors 21 adjacent to each other in the radial direction d2 is attached to the stator 2 being manufactured (holder attachment step). In this process, all the positioning members 4 are in the orientation p4a. Due to the holder 3 being attached, each of the plurality of positioning members 4 is arranged to locate between the ends 211 of the plurality of coil conductors 21 (arrangement step). This process enables the ends 211 of the plurality of coil conductors 21 to be positioned by the plurality of positioning members 4 in the subsequent steps.

In S6040, the plurality of positioning members 4 is changed from the orientation p4a to the orientation p4b using the operation portions 43 to bring the ends 211 of the two coil conductors 21 adjacent to each other in the radial direction d2 among the ends 211 of the plurality of coil conductors 21 close to each other (approach step). The orientations of the plurality of positioning members 4 are changed by the operation mechanism (not illustrated) sequentially operating the operation portions 43. As a result, it is possible to reduce a load per operation upon operating the operation portion 43, and it is possible to prevent deterioration in positioning accuracy of the ends 211 due to application of an unnecessary load to the entire system. That is, by operating the plurality of operation portions 43 one by one, the positioning members 4 can be operated with an operating force smaller than that in a case where the plurality of positioning members 4 is operated at a time, and thus, a decrease in positioning accuracy can be prevented.

For example, the operation mechanism (not illustrated) changes the positioning member 4 (referred to as “positioning member 4a for distinction), among the plurality of positioning members 4, adjacent to the ends 211 of the two coil conductors 21 adjacent to each other in the radial direction d2 on one side in the circumferential direction d3 from the orientation p4a to the orientation p4b, and then changes the positioning member 4 (referred to as “positioning member 4b” for distinction) adjacent to the ends 211 on the other side from the orientation p4a to the orientation p4b. According to such a procedure, the ends 211 of the two coil conductors 21 can be positioned with high accuracy between the positioning members 4a and 4b.

In S6045, position information of the ends 211 positioned in S6040 is acquired. An imaging device such as a camera is used to acquire the position information. The position information may include the position (height information) in the axial direction d1 in addition to the position information (position information in the horizontal direction) in the radial direction d2 and the circumferential direction d3 of each end 211. The location of the positioned end 211 may be corrected on the basis of the information regarding the stator 2 acquired in S6020 and the position information acquired in this step and may be calculated as a work position. Through these calculation processes, the distance from the axial center of the stator 2 and the relative position (for example, a direction, an angle, a distance, or the like) between the work positions can be acquired for each work position. Note that the calculation result acquired in this manner may be calculated only on the basis of the information acquired in S6020.

In S6050, the stator body 20 supported by the support 11 is rotated in the circumferential direction d3 (rotation step). The rotation direction here is the −d3 direction (clockwise). In this step, it can be said that the controller 14 functions as a rotation control unit that rotates the support 11 in the circumferential direction d3. The rotation speed is detected by the speed detection unit 123.

In S6060, the ends 211 (referred to as “ends 211a” for distinction) of the two coil conductors 21 adjacent to each other in the radial direction d2 are joined by the joining tool 13a while the rotation of the stator body 20 is maintained (joining step). Here, it is assumed that the ends 211a are located on the outer circumferential track c1.

The stator body 20 keeps rotating until it is determined in S6070 described later that the joining of all of the ends 211 on the outer circumferential track c1 has been completed. Therefore, during a period from the start of the joining to the completion of the joining, the joining tool 13a moves with the rotation of the stator body 20 and moves together with the ends 211a to be joined. Therefore, in the joining step, the joining tool 13a moves along an arc path.

In this step, it can be said that the controller 14 functions as a drive control unit that controls the joining tool 13a and the arm portion 13b so as to join the ends 211 (here, the ends 211a1 and 211a2) of the two coil conductors 21 adjacent to each other in the radial direction d2.

Note that given ends (here, the ends 211a1 and 211a2) to be joined first among the ends 211 on the outer circumferential track c1 may be optionally determined within a possible movement range of the arm portion 13b of the joining tool 13a from the start of the joining to the completion of the joining.

In S6070, it is determined whether or not joining has been completed for all of the ends 211 on the outer circumferential track c1. When the joining has been completed, the flowchart proceeds to S6550, and when the joining has not been completed, the flowchart proceeds to S6060.

In S6080, after the joining of the ends 211 is completed in S6060 (joining step), the joining tool 13a is moved from the ends 211 to the other different ends 211 (next ends 211) in the circumferential direction d3 (movement step). In this step, it can be said that the controller 14 functions as a movement control unit that moves the joining tool 13a by the arm portion 13b from the ends 211 (here, the ends 211a) that have been joined to the other different ends 211 (here, the ends 211b) in the circumferential direction d3. That is, it can be said that, when the stator 2 rotates clockwise (in the −d3 direction), the joining tool 13a substantially moves counterclockwise (in the +d3 direction) in the movement step.

Note that, in the present embodiment, the ends 211 to be joined next after the ends 211a have been joined to each other are the ends 211b adjacent to the ends 211a in the circumferential direction d3. However, as another example, the ends 211a and the ends 211b may not be adjacent to each other, and for example, other ends 211 may further be present between the ends 211a and the ends 211b.

The stator body 20 keeps rotating during the movement of the joining tool 13a, and thus, the ends 211b which are the next destination also move with the rotation. Therefore, the controller 14 calculates the positions of the ends 211b on the basis the detection result of the speed detection unit 123, calculates the relative position of the joining tool 13a with respect to the ends 211b on the basis of the calculated positions, and controls the movement of the joining tool 13a on the basis of the calculation result.

Note that the position here may be expressed as “coordinates”, and in that case, the rotation axis of the stator 2 (or the motor) may be the origin.

Furthermore, the destination here can be said to be a position where the joining of the ends 211 by the joining tool 13a can be started. Therefore, when the joining tool 13a reaches the destination, the joining tool 13a can quickly start welding at the destination. This will be described in detail later.

In addition, the stator body 20 keeps rotating during the movement of the joining tool 13a, and thus, the ends 211b which are the next destination of the joining tool 13a move toward the joining tool 13a. That is, both the joining tool 13a and the ends 211b move so as to approach each other. Therefore, the movement distance and the movement time can be shortened as compared with a case where only the joining tool 13a is moved, whereby the manufacturing efficiency can be improved.

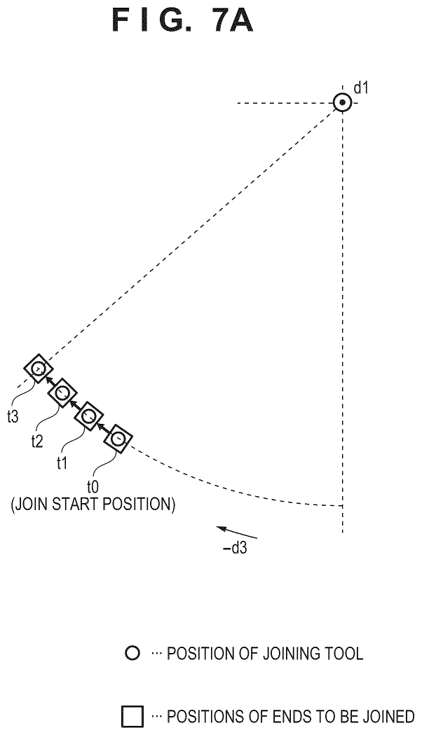

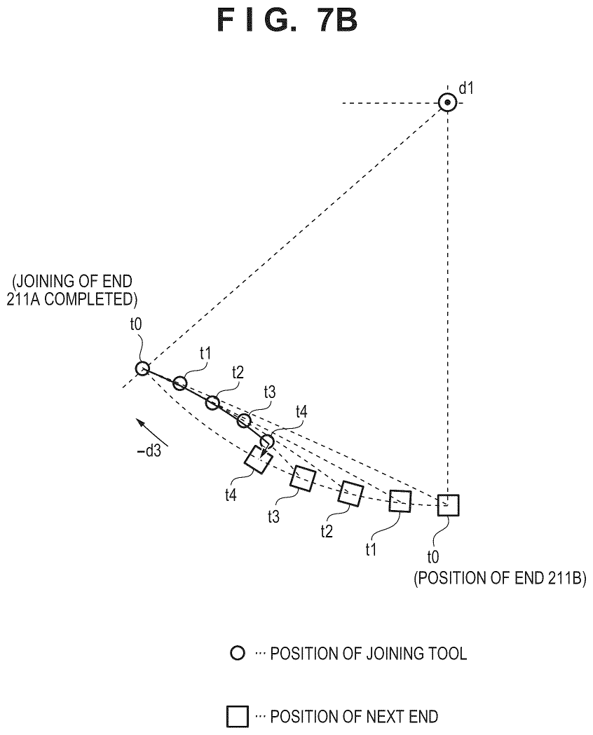

As illustrated in FIG. 7A, in S6060 (joining step), the joining tool 13a moves with the rotation of the stator body 20 along a path similar to the movement path of the end 211a, as viewed in the axial direction d1. That is, the joining tool 13a moves in an arc along the circumferential direction d3 (here, along the outer circumferential track c1). Then, as illustrated in FIG. 7B, the joining tool 13a moves in a path passing through the inner side of the arc in the radial direction d2 in S6080 (movement step). As a result, the movement distance of the joining tool 13a in S6080 (movement step) can be shortened, and the time required for moving the joining tool 13a can be reduced.

In the present embodiment, the path of the joining tool 13a in S6080 (movement step) is located on the inner side in the radial direction d2 with respect to the arc formed in S6060 (joining step), but the path of the joining tool 13a is not limited to the one in the present embodiment. For example, the joining tool 13a may move in a path substantially the same as the arc. With this configuration, a load of the controller 14 calculating the path, for example, can be reduced. Alternatively, the joining tool 13a may move in a path that passes through the outer side of the arc in the radial direction d2. This configuration makes it possible to also prevent the joining tool 13a from interfering with, for example, the camera monitoring the individual ends 211.

In order to enable the above process relatively simply, the controller 14 controls the movement of the joining tool 13a to the ends 211b on the basis of:
a current position of the joining tool 13a;
positions of the ends 211b to be joined next at a timing at which the joining of the ends 211a is completed;
an elapsed time from completion of the joining of the ends 211a;
a distance between each end 211 calculated in S6045 and the rotation axis CL of the stator 2; and
a rotation speed of the stator 2 detected by the speed detection unit 123.

During the movement control of the joining tool 13a, the controller 14 calculates, in a predetermined cycle (control cycle), the positions of the ends 211b on the basis of:
positions of the ends 211b at a timing at which the joining of the ends 211a is completed;
an elapsed time from completion of the joining of the ends 211a;
a distance between the ends 211b and the rotation axis CL of the stator 2; and
a rotation speed of the stator 2.

Thereafter, the controller 14 moves the joining tool 13a toward the calculated positions. At this time, the controller 14 moves the joining tool 13a along the shortest path. Therefore, the joining tool 13a moves in a path passing through the inner side of the arc formed in S6050 in the radial direction d2 in S6080 (movement step).

That is, the calculated positions of the next ends 211b, which are the destination of the joining tool 13a, are updated every control cycle. Here, when the position of the joining tool 13a substantially coincides with the calculated positions of the ends 211b, it is determined that S6080 (movement step) has been completed. A time sufficient for the joining tool 13a to approach the ends 211b may be set in advance, and it may be determined that S6080 (movement step) has been completed in response to the elapse of the time.

The control cycle of the controller 14 may be sufficiently shorter than the maximum value of the time taken for joining by the joining tool 13a in S6060 (joining step) and the time taken for the joining tool 13a to move to the next ends 211b in S6080 (movement step). For example, the control cycle tₛ of the joining tool 13a may be determined on the basis of the arithmetic processing capability of the controller 14.

FIG. 7A illustrates the positions of the joining tool 13a and the ends 211 during joining of the ends 211 at time t0 (=tₛ×0), time t1 (=tₛ×1), time t2 (=tₛ×2), and time t3 (=tₛ×3).

FIG. 7B illustrates the positions of the joining tool 13a and the ends 211b from a period from the completion of the joining of the ends 211a to the start of the joining of the ends 211b at time t0 (=tₛ×0), time t1 (=tₛ×1), time t2 (=tₛ×2), time t3 (=tₛ×3), and time t4 (=tₛ×4).

Here, the rotation speed of the stator 2 can be maintained constant, but the rotation speed of the stator 2 may vary during the movement of the joining tool 13a. In that case, the controller 14 controls the speed detection unit 123 so that the speed detection unit 123 detects the rotation speed of the stator 2 periodically (every control cycle), and feeds back the detection result to the control content.

Referring again to FIG. 6, after S6080 (movement step), S6060 (joining step) is performed again. That is, steps S6060 to S6080 are repeated until joining is completed for all the ends 211 on the outer circumferential track c1, and when the joining is completed, the flowchart proceeds to S6550.

As can be seen from FIGS. 7A and 7B, the joining start position in S6060 (joining step) and the movement completion position in S6080 (movement step) substantially coincide with each other, and the joining completion position in S6060 and the movement start position in S6080 substantially coincide with each other. Therefore, by repeatedly performing S6060 to S6080, the joining tool 13a is always present within a certain section including the movement path during the joining step and the movement step until the joining is completed for all the ends 211 on the outer circumferential track c1. The same applies to S6560 to S6580 described later.

Here, when an object is melted and joined by arc welding, it is necessary to inject an inert gas (shielding gas) to a joining portion. The inert gas is a gas containing carbon dioxide gas, argon, or the like as a main component, and prevents the weld metal at the joining portion from coming into contact with and reacting with the surrounding air. In general, when joining by arc welding is performed at a plurality of locations, it is necessary to perform an operation called an atmosphere creating operation for injecting an inert gas for a certain period of time for each joining portion and filling the periphery of the joining portion with the inert gas before the start of joining.

In the present embodiment, as described above, the movement region of the joining tool 13a is within a fixed section, and thus, when the injection of the inert gas is started before the start of the joining of the first joining portion, and thereafter, the inert gas is continuously injected to the fixed section at all times, the fixed section where the joining is performed can be maintained in a state of being filled with the inert gas. Therefore, it is not necessary to provide a time required to create an atmosphere satisfying the joining conditions of each end 211 unnecessarily (for example, for each joining step of the ends 211), whereby the manufacturing efficiency can be appropriately improved.

In steps after S6550, all of the ends 211 on the inner circumferential track c2 are joined in the same manner as in S6050 to S6080.

In S6550, the rotation direction of the stator 2 is set to a direction opposite to the direction in S6050 (rotation step). The rotation direction here is the +d3 direction (counterclockwise). That is, the stator 2 rotates in opposite directions between the joining of the ends 211 on the outer circumferential track c1 and the joining of the ends 211 on the inner circumferential track c2.

According to such a joining mode, the stator 2 does not make two or more rotations in the same direction, and thus, it is possible to prevent disconnection and entanglement of cables or the like that can be attached to the rotation mechanism 12.

The details of S6560 to S6580 are similar to those of S6060 to S6080, and thus, the detailed description thereof will be omitted here. Steps S6560 to S6580 are repeated until joining is completed for all the ends 211 on the inner circumferential track c2, and when the joining is completed, the flowchart ends.

To sum up, in S6050 (rotation step), the stator 2 is rotated in a state where the ends 211 of the two coil conductors 21 adjacent to each other in the radial direction d2 are positioned by the holder 3 in advance. Then, in S6060 (joining step), the ends 211 of the two coil conductors 21 are joined while the joining tool 13a is moved with the rotation of the stator 2, and in S6080 (movement step), the joining tool 13a is moved during the movement of the ends 211 of the two coil conductors 21 in the circumferential direction d3 due to the rotation of the stator 2. According to such a joining mode, it is possible to relatively easily connect the ends 211 of the plurality of coil conductors 21. Further, the stator 2 continuously rotates (it is not necessary to intermittently stop the rotation of the stator 2), so that the work efficiency of the entire system can be improved. The same applies to steps after S6550.

In the present embodiment, the rotating direction of the stator 2 in S6050 (rotation step) and the moving direction of the joining tool 13a in S6080 (movement step) are substantially opposite each other. Therefore, the time required for moving the joining tool 13a can be appropriately shortened. The same applies to steps after S6550.

Furthermore, in the present embodiment, the ends 211 (for example, the ends 211a1 and 211a2) of two rows on the outer side along the outer circumferential track c1 among the ends 211 arranged at predetermined intervals in the circumferential direction d3 and arrayed in four rows in the radial direction d2 are sequentially joined by S6060 (joining step). Further, the ends 211 (for example, the ends 211a3 and 211a4) of two rows on the inner side along the inner circumferential track c2 are sequentially joined by S6560 (joining step). The stator body 20 rotates in opposite directions between S6060 and S6560. That is, the stator body 20 makes only one rotation in opposite directions for joining the ends 211 on the outer circumferential track c1 and for joining the ends 211 on the inner circumferential track c2. This makes it possible to prevent disconnection and entanglement of cables or the like that can be attached to the rotation mechanism 12.

The flowchart described above may be partially changed without departing from the spirit thereof. For example, the order of some steps can be changed, and some steps may be executed in parallel with other steps. As an example, after the ends 211 (for example, the ends 211a1 and 211a2) of two rows on the outer side along the outer circumferential track c1 are joined as one set in S6060 (joining step), the joining tool 13a may be moved to the ends 211 (for example, the ends 211a3 and 211a4) of two rows on the inner side along the inner circumferential track c2 and the ends 211 may be joined as one set.

In that case, it may be determined whether or not the joining of all of the ends 211 on the outer circumferential track c1 and the inner circumferential track c2 have been completed in the same procedure as in S6070 after the joining step. When the joining has been completed, this flowchart ends, and when the joining has not been completed, the joining tool 13a is moved to the other ends 211 of the two rows on the outer side along the outer circumferential track c1 to perform the joining step.

As another example, the orientation of two or more positioning members 4 may be simultaneously changed in S6040 (approach step). In that case, the number of operation mechanisms (not illustrated) that operate the operation portion 43 may be increased, and when the operation mechanism (not illustrated) is a mechanism such as a manipulator, the output of a power source of the mechanism may be increased.

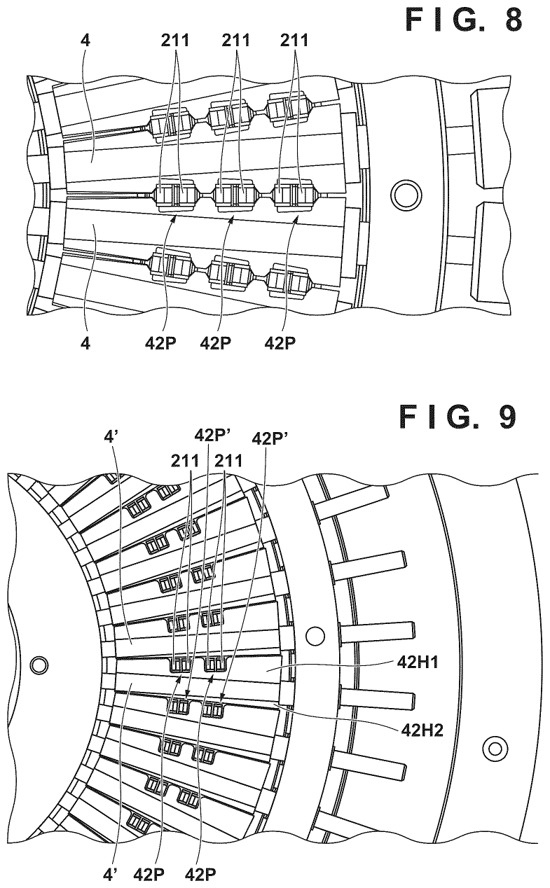

In the present embodiment, the plurality of coil conductors 21 is arranged such that the ends 211 are arranged in a total of four rows including two rows along the outer circumferential track c1 and two rows along the inner circumferential track c2, but the number of rows of the ends 211 is not limited thereto. For example, as illustrated in FIG. 8, the plurality of coil conductors 21 may be arranged such that the ends 211 thereof are arrayed in a total of six rows along three circumferential tracks. Alternatively, the number of rows of the ends 211 may be eight or more. That is, the number of rows of the ends 211 can be changed on the basis of the mechanical structure and/or electrical performance required for the stator 2.

### Summary of Embodiments

As one aspect of the above-described embodiment, in the method for manufacturing the stator 2 to be mounted on the motor, the stator 2 is rotated in a state where the ends 211 of the two coil conductors 21 adjacent to each other in the radial direction d2 are positioned by the holder 3 in advance in the rotation step (for example, S6050). In the joining step (for example, S6060), the ends 211 of the two coil conductors 21 are joined while the joining tool 13a is moved with the rotation of the stator 2, and in the movement step (for example, S6080), the joining tool 13a is moved during the movement of the ends 211 of the two coil conductors 21 in the circumferential direction d3. According to such a joining mode, it is possible to relatively easily connect the ends 211 of the plurality of coil conductors 21. Further, the stator 2 continuously rotates (it is not necessary to intermittently stop the rotation of the stator 2), so that an unnecessary load is not applied to the entire system.

In addition, according to the embodiment, when the joining tool 13a moves to the next ends 211 (for example, the ends 211b) after completion of joining of given ends 211 (for example, the ends 211a), the moving direction thereof is opposite to the rotation direction of the stator 2. Therefore, it is possible to prevent unnecessary movement of the joining tool 13a and shorten a distance of reciprocating movement of the joining tool 13a, and further, it is also possible to join the ends 211 in a relatively short time in a state where the ends 211 of the plurality of coil conductors 21 are positioned. These are advantageous in improving the manufacturing efficiency of the stator 2, and are particularly advantageous in increasing the size of the motor.

As another aspect, the holder 3 for positioning the ends 211 of the plurality of coil conductors 21 includes a plurality of positioning members 4 and holding portions 31a and 31b. Each of the positioning members 4 is a rod-shaped member extending in the radial direction d2, and includes a rotation shaft 41 rotatable about the radial direction d2 as a rotation axis, and a positioning portion 42 provided to extend to one side and another side in a direction orthogonal to the radial direction d2. Each of the plurality of positioning members 4 is arranged to locate between the ends 211 of the plurality of coil conductors 21. Thus, the ends 211 of the plurality of coil conductors 21 can be positioned, and the stator 2 can be manufactured relatively easily, so that the manufacturing efficiency of the stator 2 can be improved.

As another example, the positioning contact portion 42P of the positioning member 4 may be provided only on the side portion 42E on one side in the direction orthogonal to the radial direction d2. FIG. 9 illustrates a mode of positioning by a positioning member 4′ as another example of the structure capable of positioning the ends 211 of the plurality of coil conductors 21.

### Positioning Member 4′:

In one of the blade portions 42H (denoted as “blade portion 42H1” for distinction), two positioning contact portions 42P (for example, the contact portions 42P1 and 42P2, or 42P3 and 42P4) are provided on the side portion 42E (denoted as “side portion 42E1” for distinction), and
in the other blade portion 42H (denoted as “blade portion 42H2” for distinction), the side portion 42E (denoted as “side portion 42E2” for distinction) is substantially linearly formed, and the side portion 42E2 functions as a contact portion (denoted as “contact portion 42P′” for distinction).

In that case, as illustrated in FIG. 9, when the ends 211 of the plurality of coil conductors 21 are positioned, the ends 211 are fixed or retained by the positioning contact portion 42P of a given positioning member 4′ and the contact portion 42P′ of the adjacent positioning member 4′. With this configuration, the ends 211 of the plurality of coil conductors 21 can also be positioned, and the same effect as described above can be obtained. Note that the contact portion 42P′ may be expressed as a positioning contact portion 42P′. Alternatively, in order to distinguish the positioning contact portion 42P and the contact portion 42P′, the positioning contact portion 42P may be expressed as a recessed contact portion 42P, and the contact portion 42P′ may be expressed as a linear contact portion 42P′.

While the method for manufacturing the stator 2 for a three-phase motor has been described in the embodiment, the contents of the embodiment are not limited to the modes described herein and can also be applied to manufacturing other motors of a known system.

The names of the individual elements or functional units described in the above-described embodiment are expressed on the basis of main functions in the present specification, but may be expressed on the basis of sub-functions. Therefore, in the present invention, the individual elements or functional units are not strictly limited by the corresponding expressions (the expressions can be replaced with similar expressions). For the same purpose, the expression “unit” may be replaced with “component or piece”, “member”, “structure”, “assembly”, “tool”, “circuit or module”, “means”, or the like, or may be omitted.

In the above description, each element is indicated by a name related to its function for facilitating understanding, but each element is not limited to the one having the content described in the embodiment as a main function, and may be the one having the content as an auxiliary function.

What is claimed is:

1. A holder for positioning ends of a plurality of coil conductors constituting a coil of a stator to be mounted on a motor, the holder comprising:
a plurality of positioning members arranged side by side at predetermined intervals in a circumferential direction so as to be able to position the ends of the plurality of coil conductors;
an outer annular member that is disposed on an outer side that is one side in a radial direction, the outer annular member holding the plurality of positioning members; and
an inner annular member that is disposed on an inner side that is another side in the radial direction, the inner annular member holding the plurality of positioning members, wherein
each of the positioning members is a rod-shaped member extending in the radial direction, and includes
a rotation shaft configured to be rotatable about the radial direction as a rotation axis, and
a positioning portion provided to extend to one side and another side in a direction orthogonal to the radial direction,
the ends of the plurality of coil conductors protrude in an axial direction of the motor and are arranged in the circumferential direction so as to form a row in the radial direction,
each of the plurality of positioning members is arranged to be located between a plurality of the rows of the ends of the plurality of coil conductors arranged in the circumferential direction,
the outer annular member is provided with a plurality of first holding portions that respectively holds sections on one side in the radial direction of the rotation shafts of the plurality of positioning members in a rotatable manner,
the inner annular member is provided with a plurality of second holding portions that respectively holds sections on another side in the radial direction of the rotation shafts of the plurality of positioning members in a rotatable manner, and
each of the positioning members rotates about the radial direction as a rotation axis to
bring a section of the positioning portion extending to the one side in contact with the ends forming the rows on one side in the circumferential direction,
bring a section of the positioning portion extending to another side in contact with the ends forming the rows on another side in the circumferential direction, and
position the ends forming the rows together with the positioning portion of another adjacent positioning member in the circumferential direction among the plurality of positioning members.

2. The holder according to claim 1, wherein
the positioning portion includes:
a first positioning contact portion configure to come in contact, in the circumferential direction, with the ends forming the rows on the one side in the circumferential direction; and
a second positioning contact portion configure to come in contact, in the circumferential direction, with the ends forming the rows on the another side in the circumferential direction,
and
the first positioning contact portion further comes in contact, in the radial direction, with the ends forming the rows on one side in the circumferential direction.

3. The holder according to claim 1, wherein
the positioning portion includes:
a first positioning contact portion configure to come in contact, in the circumferential direction and the radial direction, with the ends forming the rows on the one side in the circumferential direction; and
a second positioning contact portion configure to come in contact, in the circumferential direction and the radial direction, with the ends forming the rows on the another side in the circumferential direction.

4. The holder according to claim 1, wherein
the positioning portion includes: a first contact portion that comes in contact, in the radial direction, with one of two ends adjacent to each other in the radial direction among the ends; and a second contact portion that comes in contact, in the radial direction, with another of the two ends.

5. The holder according to claim 4, wherein
each of the positioning members has
a first orientation in which the positioning portion is oriented in the axial direction, and
a second orientation in which the positioning portion is oriented in the circumferential direction,
in the second orientation,
the section of the positioning portion extending to the one side comes in contact with the ends forming the rows on one side in the circumferential direction, and
the section of the positioning portion extending to the another side comes in contact with the ends forming the rows on the another side in the circumferential direction, and
each of the positioning members further includes an operation portion configured to be operable when the positioning member is switched between the first orientation and the second orientation.

6. The holder according to claim 1, wherein
the positioning portion includes a pair of blade portions extending to the one side and the another side in the direction orthogonal to the radial direction, each of the blade portions including a side portion formed to have a width increasing from the inner side to the outer side in the radial direction, and
when each of the positioning members positions the ends forming the rows together with the positioning portion of the other adjacent positioning member in the circumferential direction by the rotation, the blade portions of the positioning portion of the positioning member and the blade portions of the positioning portion of the other positioning member are close to each other in such a manner that the side portions of the positioning member and the other positioning member are parallel to each other.

7. The holder according to claim 6, wherein
the side portion includes a positioning contact portion that has a recessed shape and that includes a first inclined surface, a second inclined surface, and a connection surface connecting the first inclined surface and the second inclined surface, and
the first inclined surface and the second inclined surface are inclined in such a manner that a distance between the first inclined surface and the second inclined surface increases with distance from the rotation shaft.

8. A method for manufacturing the stator using the holder according to claim 1, the method comprising:
a holder attachment step of attaching the holder to the stator;
a rotation step of rotating a main body of the stator, to which the holder is attached, in the circumferential direction with the main body of the stator being supported from one end side in the axial direction;
a joining step of joining ends of two coil conductors adjacent to each other in the radial direction using a joining tool, the ends protruding from another end side in the axial direction of the main body of the stator; and
a movement step of moving the joining tool from the ends to other different ends in the circumferential direction after completion of joining of the ends, wherein
each of the positioning members has
a first orientation in which the positioning portion is oriented in the axial direction, and
a second orientation in which the positioning portion is oriented in the circumferential direction,
the holder attachment step includes attaching the holder in such a manner that each of the plurality of positioning members in the first orientation is located between a plurality of rows of the ends of the plurality of coil conductors arranged in the circumferential direction,
the method further includes
a positioning step of positioning the ends forming the rows on one side in the circumferential direction and the ends forming the rows on another side in the circumferential direction with respect to the individual positioning members by sequentially operating the plurality of positioning members for switching the positioning members from the first orientation to the second orientation,
the rotation step includes rotating the stator and the holder with the ends of the plurality of coil conductors being positioned in advance by the holder,
the joining step includes joining the ends of two coil conductors that are adjacent to each other in the radial direction among the plurality of coil conductors and that are positioned by the holder while moving the joining tool with the rotation of the stator, and
the movement step includes moving the joining tool during movement of the stator and the holder in the circumferential direction.

9. The method according to claim 8, wherein
the ends joined by the joining step are defined as first ends, the other ends are defined as second ends, and
the movement step includes moving the joining tool on the basis of a distance between positions of the first ends and positions of the second ends and a rotation speed of the stator.

10. The method according to claim 8, further comprising
a second joining step of joining the other ends by the joining tool after the movement step, wherein
the movement step includes moving the joining tool to the other ends on the basis of a position where joining of the other ends is started in the second joining step and a rotation speed of the stator.

11. The method according to claim 8, wherein
the ends of the plurality of coil conductors are arranged in the radial direction and arrayed along a plurality of circumferential tracks in the circumferential direction,
the plurality of circumferential tracks includes a first circumferential track and a second circumferential track, and
the joining step includes:
sequentially joining the ends of the two coil conductors adjacent to each other in the radial direction along the first circumferential track during rotation of the main body of the stator; and
sequentially joining the ends of other two coil conductors adjacent to each other in the radial direction along the second circumferential track during rotation of the main body of the stator.

12. A manufacturing device for manufacturing the stator using the holder according to claim 1, the manufacturing device comprising:
a support configured to support a main body of the stator to which the holder is attached from one end side in the axial direction;
a rotation mechanism configured to rotate the support in the circumferential direction;
a joining tool disposed on another end side in the axial direction with respect to the main body of the stator; and
a controller configured to perform drive control of the joining tool.

13. The manufacturing device according to claim 12, wherein
the support includes:
a stand configured to support a lower end of the main body of the stator; and
a column portion extending to pass through an inside of the main body of the stator and supporting the holder, and
the column portion includes a defining portion that defines a position of the holder supported by the column portion.
